(19) United States
(12) Patent Application Publication
(10) Pub. No.: US 2009/0246601 A1
(43) Pub. Date: Oct. 1, 2009

(54) PROCESS FOR PREPARING CATALYST MATERIAL

(76) Inventors: Naoko Iwata, Aichi (JP); Makoto Yuasa, Saitama (JP); Kenichi Oyaizu, Tokyo (JP); Ken Tanaka, Saitama (JP); Yuichi Iai, Tokyo (JP); Masakuni Yamamoto, Tochigi (JP); Shinichi Sasaki, Miyagi (JP); Shigeru Kido, Fukushima (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/282,060

(22) PCT Filed: Mar. 9, 2007
(86) PCT No.: PCT/JP2007/055315

§ 371 Date: May 8, 2009

(30) Foreign Application Priority Data
Mar. 9, 2006 (JP) 2006-063939

(51) Int. Cl. H01M 4/86; H01M 4/88

(52) U.S. Cl. 429/40; 502/101

(57) ABSTRACT

The present invention is intended to provide a catalyst material that supports active species densely, thereby having higher catalytic performance and serviceability as, for example, an electrode for fuel cells. To achieve the above object, the present invention provides a process for preparing a catalyst material, including: an electrochemical polymerization step of electrochemically polymerizing a heteromonocyclic compound so that the surface of a conductive material is coated with polynuclear complex molecules derived from the heteromonocyclic compound; and a metallation step of coordinating a catalytic metal to the coating layer of the polynuclear complex molecules, characterized in that the potential applied in the electrochemical polymerization is 0.8 to 1.5 V.

### TECHNICAL FIELD

The present invention relates to a process for preparing a catalyst material, in particular, to a process for preparing a catalyst material that supports active species densely, thereby having high catalytic activity and being suitable as a catalyst for fuel cells.

### BACKGROUND ART

Recently many investigations have been made of electrode systems, as electrode catalysts, which have undergone surface modification with a macrocyclic compound, such as porphyrin, chlorophyll, phthalocyanine, tetraazaannulene or Schiff base, or a derivative thereof. And these electrode systems are expected to be applied, as electrode catalysts which take the place of platinum (Pt) and its alloys, to the cathode of (oxygen-hydrogen) fuel cells, such as phosphoric acid fuel cells or polymer electrolyte fuel cells, by utilizing the electrochemical multielectron reduction properties of molecular oxygen (O₂) due to such electrode catalysts (see Hyomen Gijyutsu (The Journal of the Surface Finishing Society of Japan)”, vol. 46, No. 4, 19-26 and “POLYMERS FOR ADVANCED TECHNOLOGYS”, No. 12, P. 266-270 (2001))).

However, the catalytic activity of the electrode systems utilizing any of the above macrocyclic compounds is insufficient to use the systems in fuel cells. Under these circumstances, there have been demands for development of catalyst materials having higher catalytic performance and serviceability.

### DISCLOSURE OF THE INVENTION

It is therefore an object of the present invention to provide a catalyst material that has an active species densely, thereby having higher catalytic performance and serviceability as, for example, an electrode of fuel cells.

To solve the above problem, first, the present inventors examined the reasons why the electrode catalysts utilizing a macrocyclic compound do not have sufficiently high catalyst activity. And they inferred from the examination that in macrocyclic compounds, the density of an active species is lowered when it is supported on a catalyst support, whereby the activity of the catalyst electrode utilizing a macrocyclic compound is decreased. The present inventors have found through the examination that if a catalyst support is coated with a heteromonocyclic compound or a polynuclear polymer derived from the heteromonocyclic compound, a lot of M-N₄ structure where a catalyst metal is coordinated is formed, whereby a catalyst material having high catalytic activity is obtained.

Thus, the present inventors have invented a catalyst material, prepared by coordinating a catalytic metal to the coordination sites of a conductive material coated with a polynuclear polymer, the coordination sites being formed by the polynuclear polymer, characterized in that the polynuclear polymer is derived form a heteromonocyclic compound.

After dedicating their efforts to the investigation, the present inventors have found that when the polynuclear complex molecule is obtained by electrochemically polymerizing a heteromonocyclic compound under the specified conditions (voltage applied, solvent, supporting electrolyte), the resultant catalyst material has an active species densely and has significantly improved catalytic activity, and they have reached the present invention. Further, the present inventors have found that when a specified polymerizable ligand is used as the polynuclear complex molecule subject to electrochemical polymerization, the resultant catalyst material has significantly improved catalytic activity, and they have reached the present invention. And after examining the characteristics of the conductive material used as a support, the present inventors have also found that when the material has a specified specific surface area and average particle size, the resultant catalyst material has significantly improved catalytic activity, and they have reached the present invention. Further, they have found that repeating the electrochemical polymerization and/or the coordination of catalytic metal (metallation) several times is effective in increasing the density of active species supported on a catalyst material and improving the catalytic activity of the catalytic material, and they have reached the present invention. Further, they have found that using an ancillary ligand when repeating the electrochemical polymerization and/or the coordination of catalytic metal (metallation) several times is effective in improving the coordination tendency of a catalytic metal, and they have reached the present invention. Further, they have found that when a noble metal and a transition metal are coordinated to the coating layer at the same time, the resultant catalyst material has significantly improved catalytic activity, and they have reached the present invention.

First, the present invention is a process for preparing a catalyst material, including: an electrochemical polymerization step of electrochemically polymerizing a heteromonocyclic compound so that the surface of a conductive material is coated with a polynuclear polymer derived from the heteromonocyclic compound; and a metallation step of coordinating a catalytic metal to the coating layer of the polynuclear polymer, characterized in that the potential applied in the electrochemical polymerization is 0.8 to 1.5 V.

In the present invention, preferable examples of the heteromonocyclic compound include monocyclic compounds each having pyrrole, dimethylpyrrole, pyrrole-2-carboxyaldehyde, pyrrole-2-alcohol, vinylpyridine, aminobenzoic acid, aniline or thiophene as a basic skeleton. Preferable examples of polynuclear polymers obtained by electrochemical polymerization include polypyrrole complex, polyvinylpyridine complex, polianiline complex and polythiophene complex. The procedure of electrochemically polymerizing a heteromonocyclic compound is known by various known documents.

In the present invention, preferably the electrochemical polymerization step is carried out in any of various known solvents and particularly preferably in a water-methanol or water-ethanol mixed solvent.

Further, preferably the electrochemical polymerization step is carried out using NH₄ClO₄ or PTS as a supporting electrolyte.

In the process for preparing a catalyst material of the present invention, as the heteromonocyclic compound, any one of various known electrochemically polymerizable heteromonocyclic compounds is used. Particularly when using 2-(1H-pyrrol-3-ylpyridine), which is a polymerizable ligand in which pyridine and pyrrole are bonded with each other, a catalyst material having improved catalytic activity is obtained.

In the present invention, preferably the conductive material, as a support for the catalyst material, has a specific surface area of 500 to 2000 m²/g and more preferably 800 to 1500 m²/g. Also preferably the conductive material has an average particle size of 3 to 30 nm and more preferably 3 to 10 nm.

In the process for preparing a catalyst material of the present invention, preferably the electrochemical polymerization step and/or the metallation step is carried out more than one time. Specifically, in the process for preparing a catalyst material which includes an electrochemical polymerization step of electrochemically polymerizing a heteromonocyclic compound so the surface of a conductive material is coated with the polynuclear polymer derived from the heteromonocyclic compound; and a metallation step of coordinating a catalytic metal to the coating layer of the polynuclear polymer, preferably the electrochemical polymerization step and/or the metallation step is carried out more than one time. These steps enable the increase in the density of an active species supported on the catalyst material, thereby improving the catalytic activity of the same.

In the present invention, preferably at least two heteromonocyclic compounds are electrochemically polymerized in the electrochemical polymerization step.

In the present invention, preferably not only a noble metal, but also a transition metal is coordinated in the metallation step.

Preferably the process for preparing a catalyst material of the present invention also includes a heat treatment step to be carried after the metallation step. Heat treatment enables the significant improvement of the catalytic activity of the catalyst material. Preferably the heat treatment is carried out, for example, at 400 to 700° C. for 2 to 4 hours, though the concrete heat treatment conditions vary depending on the catalyst components and the heating temperature.

In the present invention, not only coordinating a catalytic metal to the polynuclear polymer obtained by electrochemically polymerizing a heteromonocyclic compound, but also coordinating a low-molecular-weight heterocyclic compound, as an ancillary ligand, to the catalytic metal is effective in enhancing the coordination tendency of the catalyst and improving the density of the polynuclear ligand molecules, as active species, supported.

In the present invention, the term “ancillary ligand” means a low-molecular-weight compound that has the function of more completely achieving the coordination of a catalytic metal by assisting in coordinating “the polynuclear molecules derived from a heteromonocyclic compound” to the catalytic metal. Preferable examples of such ancillary ligands include low-molecular-weight heterocyclic compounds. Use of an ancillary ligand makes it possible to improve the catalytic activity of a catalyst material. For example, it is preferable from the viewpoint of promoting the coordination of a catalytic metal to coordinate, as an ancillary ligand, a nitrogen-containing low-molecular-weight compound, which is a low-molecular-weight heterocyclic compound, to the catalytic metal. As the nitrogen-containing low-molecular-weight compound, any one of various kinds of compounds is used. And as the low-molecular-weight heterocyclic compound, any one of various kinds of compounds is used. Of the low-molecular-weight heterocyclic compounds, preferable are pyridine, which have one nitrogen atom as a hetero atom, and phenanthroline, which has two nitrogen atoms as hetero atoms.

The noble metal(s) employed for the catalyst material prepared in the present invention is not limited to any specific noble metal(s), and any known metal(s) used for catalyst materials, particularly for catalysts for fuel cells, can be used. The combination of noble metal(s) and transition metal(s) can also be used. Preferable examples of combinations of noble metal(s) and transition metal(s) include combinations of: one or more noble metals selected from the group consisting of palladium (Pd), iridium (Ir), rhodium (Rh) and platinum (Pt); and one or more transition metals selected from the group consisting of cobalt (Co), iron (Fe), molybdenum (Mo) and chromium (Cr). Of these combinations, particularly preferable are the combination of iridium (Ir), as a noble metal, and cobalt (Co), as a transition metal, the combination of rhodium (Rh), as a noble metal, and cobalt (Co), as a transition metal, and the combination of palladium (Pd), as a noble metal, and cobalt (Co), as a transition metal.

In the present invention, when both noble metal(s) and transition metal(s) are coordinated to the catalyst, the content of the noble metal(s) in the catalyst material is preferably 20 to 60 wt %. If the content of the noble metal(s) is in such a range, the improvement in catalyst activity can be observed.

In the present invention, preferably the raw material for the catalyst material that contains composite catalyst metals as described above is highly purified. If the raw material for the catalyst material is highly purified, the catalytic activity is significantly improved. One example of methods for highly purifying the raw material for the catalyst material is that palladium acetate is used as a palladium material and the purity of the palladium acetate is increased by a known physical or chemical method. Although the reasons that the catalytic activity is improved by the purification of the raw material for the catalyst material have not been fully clarified yet, the improvement may be attributed to the improvement in the surface composition of N, Co, Pd, etc., which form the active sites, particularly to the significant increase in the amount of Pd introduced.

In the present invention, preferable examples of conductive materials as described above include metals, semiconductors, carbon-based compounds and conductive polymers.

Preferably the catalyst material of the present invention includes a second metal and/or its ions as well as the above catalytic metal. It is also preferable from the viewpoint of improving the activity to dope the catalyst material with anion.

The shape of the catalyst material of the present invention is not limited to any specific one. For example, it can be a particle-like, fiber-like, hollow, or corned horn-like material.

Second, the present invention is a catalyst material prepared by the above process, in particular, a catalyst for fuel cells.

Third, the present invention is a fuel cell that includes the above catalyst material as a catalyst for the fuel cell.

The catalyst material of the present invention is a material prepared by allowing a polynuclear polymer obtained under the specified electrochemical polymerization conditions to support catalytic metal(s). The material has an excellent catalytic activity, and when used as a catalyst for fuel cells, it can improve the power generation performance of fuel cells.

### BRIEF DESCRIPTION OF THE DRAWINGS

FIG. 1 is a flow diagram of the preparation of a cobalt+palladium/polypyrrole/carbon-based catalyst material of Example 1;

FIG. 2 is a flow diagram of the preparation of a catalyst material of Example 2 using 2-(1H-pyrrol-3-ylpyridine) as a polymerizable ligand;

FIG. 3 is a flow diagram of the preparation of a catalyst material of Example 3 using carbon nanotube (CNT) and Black Pearls (brand name) as catalyst supports;

FIG. 4 is a flow diagram of the preparation of a catalyst material of Example 4 employing multiple electrochemical polymerization; and

FIG. 5 is a flow diagram of the preparation of a catalyst material of Example 5 employing multiple electrochemical polymerization in combination with an ancillary ligand.

### BEST MODE FOR CARRYING OUT THE INVENTION

The catalyst material of the present invention is a material prepared by coating the surface of a conductive material with a polynuclear polymer obtained by electrochemically polymerizing a heteromonocyclic compound under the specified conditions and coordinating catalytic metal(s) to the coordination site(s) of the polynuclear polymer.

Examples of the conductive material usable for the catalyst material include: metals such as platinum, gold, silver and stainless steel; semiconductors such as silicon; and carbon-based materials such as glassy carbon, carbon black, graphite and activated carbon. From the view point of availability, cost, weight, etc., preferably a carbon-based material such as glassy carbon, carbon black, graphite or activated carbon is used as the conductive material. From the point of ensuring a large surface area, the conductive material is preferably a particle-like, fiber-like, hollow, or corned horn-like material, though it can be a sheet-like or rod-like material.

Of particle-like conductive materials, materials having an average particle size of 3 to 30 nm are preferable and materials having an average particle size of 3 to 10 nm are more preferable. As a fiber-like, hollow or cored horn-like conductive material, carbon fiber (filler), carbon nanotube or carbon nanohorn is preferable, respectively.

The polynuclear polymer that coats the conductive material is derived from a heteromonocyclic compound. Examples of heteromonocyclic compounds usable as a raw material include: monocyclic compounds each having, as a basic skeleton, pyrrole, vinylpyridine, aniline or thiophene. Particularly, pyrrole, dimethylpyrrole, pyrrole-2-carboxyaldehyde, pyrrole-2-alcohol, vinylpyridine, aniline, aminobenzoic acid, or thiophene is used as a heteromonocyclic compound.

Examples of catalytic metals which can be coordinated to the coordination sites of the polynuclear polymer include: one or more noble metals selected from the group consisting of palladium (Pd), iridium (Ir), rhodium (Rh), platinum (Pt) and the like; and one or more transition metals selected from the group consisting of cobalt (Co), iron (Fe), molybdenum (Mo), chromium (Cr), and the like which are made into composites with the noble metal(s).

As a process for deriving a polynuclear polymer from any one of the above heteromonocyclic compounds and coating the conductive material with the polynuclear polymer, an electrochemical polymerization process can be used. The electrochemical polymerization process is a process in which a heteromonocyclic compound is electrochemically polymerized on a conductive material to produce a polynuclear polymer so that the conductive material is coated with the polynuclear polymer and then a catalytic metal is allowed to act on the polynuclear polymer so that the coordination sites of the polynuclear polymer (when the polynuclear polymer is a nitrogen-containing complex compound, the M-N₄ structure sites) support the catalytic metal.

When the conductive material is a commonly used sheet-like or rod-like material, the electrochemical polymerization of a heteromonocyclic compound on the conductive material can be carried out using conventional electrochemical polymerization apparatus under conventional conditions. However, when the conductive material used is a fine particle-like, fiber-like, hollow or corned horn-like material, it is effective to use fluidized bed electrode electrochemical polymerization apparatus.

To allow a solution containing a catalytic metal to act on the conductive particles coated with the polynuclear polymer obtained by electrochemical polymerization (hereinafter referred to as “coated particles”), for example, the coated particles are suspended in a proper solution in which the catalytic metal is dissolved and the suspension is refluxed with heat under an inert gas atmosphere.

Examples of coordination compounds in which a catalytic metal is coordinately bonded to at least two heteromonocyclic compounds include: a cobalt-(poly)pyrrole 1:4 coordination compound expressed by the following chemical formula (I);

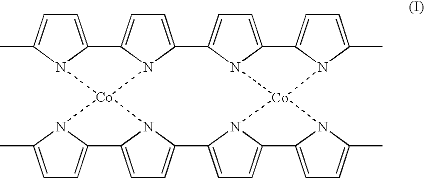

or
a cobalt-(poly)aniline 1:4 coordination compound expressed by the following chemical formula (II).

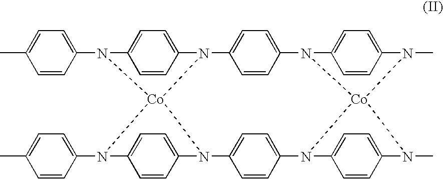

The coordination compound in which the compound of chemical formula (I) and that of chemical formula (II) are partially made composite is also included.

In the present invention, one example of coordination compounds in which a noble metal and a transition metal are coordinately bonding to at least two heteromonocyclic compounds is a composite of a cobalt-(poly)pyrrole 1:4 coordination compound expressed by the following chemical formula (III-1);

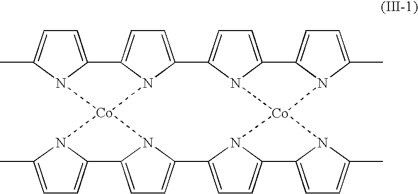

and
an iridium-(poly)pyrrole 1:4 coordination compound expressed by the following chemical formula (III-2).

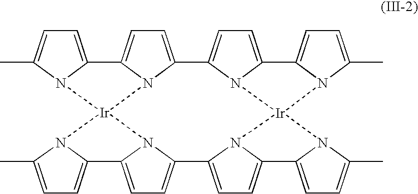

Another example of coordination compounds in which a noble metal and a transition metal are coordinately bonding to at least two heteromonocyclic compounds is a composite of a cobalt-(poly)pyrrole 1:4 coordination compound expressed by the following chemical formula (IV-1);

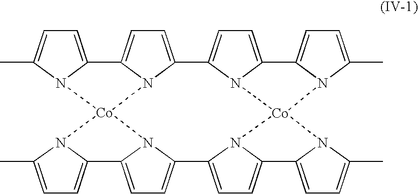

and
a rhodium-(poly)pyrrole 1:4 coordination compound expressed by the following chemical formula (IV-2).

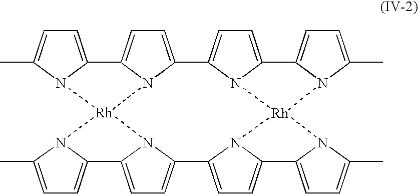

As shown in chemical formulae (I), (II), (III-1) and (III-2), and (IV-1) and (IV-2), the coordination compounds used in the present invention take the form in which the hetero atoms of the heteromonocyclic compounds (nitrogen atoms when the compounds are pyrrole and aniline, sulfur atoms when the compound is thiophene) are coordinated to the catalytic metal, and if any of the coordination compounds is electrochemically polymerized on a conductive material, the surface of the conductive material is coated with polynuclear complex molecules of a catalytic metal-supporting polynuclear polymer.

The catalyst material in which the compounds of the above formulae (I) and (II) are made composite corresponds to a catalyst material, characterized in that it is prepared by: coating the surface of a conductive material with a polynuclear polymer derived from at least two heteromonocyclic compounds; and coordinating a catalytic metal to the coating layer of the polynuclear polymer. The coordination compounds expressed by the above chemical formulae (III-1) and (III-2) and those of (IV-1) and (IV-2) correspond to catalyst materials, characterized in that they are prepared by: coating the surface of a conductive material with a polynuclear polymer derived from a heteromonocyclic compound; and coordinating catalytic metals of a noble metal and a transition metal to the coating layer of the polynuclear polymer.

When the conductive material is a commonly used sheet-like or rod-like material, the electrochemical polymerization of any of the above coordination compounds on the conductive material can be carried out using conventional electrochemical polymerization apparatus under conventional conditions. However, when the conductive material used is a fine particle-like, fiber-like, hollow or corned horn-like material, it is necessary to use fluidized bed electrode electrochemical polymerization apparatus. The electrochemical polymerization process using fluidized bed electrode electrochemical polymerization apparatus can be carried out in almost the same manner as described above, provided that any one of solvents capable of dissolving the above coordination compounds is used. Of such solvents, a mixed solvent of water-methanol or water-ethanol is suitably used.

One example of coordination compounds obtained by coordinating a catalytic metal to the polymerization product of at least two heteromonocyclic compounds is a cobalt-polypyrrole 1:4 coordination compound expressed by the following chemical formula (V-1):

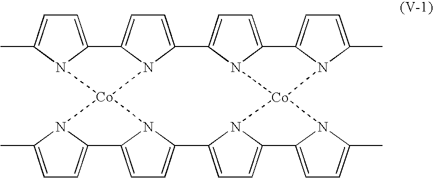

or a cobalt-polyaniline 1:4 coordination compound expressed by the following chemical formula (V-2):

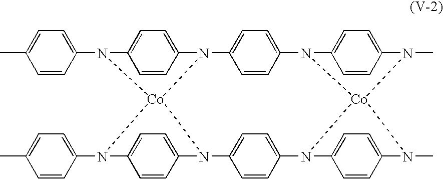

One example of coordination polymer compounds in which mixed catalytic metals of a noble metal and a transition metal are coordinated is a composite of a cobalt-polypyrrole 1:4 coordination compound expressed by the following formula (VI-1):

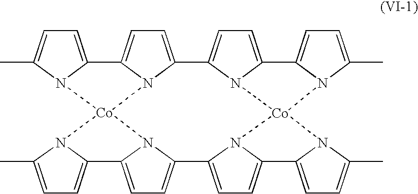

and
an iridium-polypyrrole 1:4 coordination compound expressed by the following formula (VI-2):

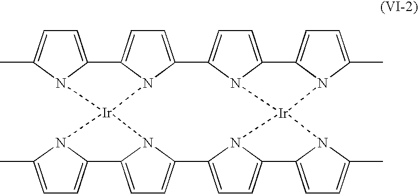

or
a composite of a cobalt-polypyrrole 1:4 coordination compound expressed by the above formula (VI-1) and a rhodium-polypyrrole 1:4 coordination compound expressed by the following formula (VI-3).

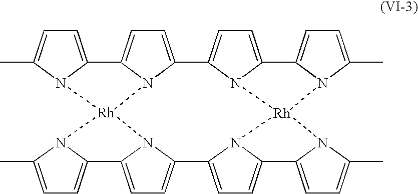

The coordination states expressed by the above chemical formulae (I) to (VI-3) show the states in which 4 nitrogen atoms or sulfur atoms in heterocycles are coordinated to a metal. In an actual polynuclear polymer derived from heteromonocyclic compounds, 4 nitrogen atoms or sulfur atoms in heterocycles are not always coordinated to one metal because of the assembly characteristics, bending state or steric hindrance of its molecules. However, even in cases where only 3 or 2 nitrogen atoms or sulfur atoms are coordinated to a metal, if a low-molecular-weight heterocyclic compound is added to the reaction system, the low-molecular-weight heterocyclic compound added acts as an ancillary ligand and it becomes possible for the low-molecular-weight heterocyclic compound to be coordinated to the metal complementarily.

The coordination compound expressed by the following chemical formula (VII) shows the state in which one low-molecular-weight heterocyclic compound, pyridine, along with 3 pyrrole units in polypyrrole are coordinated to iridium, whereby 4 nitrogen atoms are coordinated to the iridium atom.

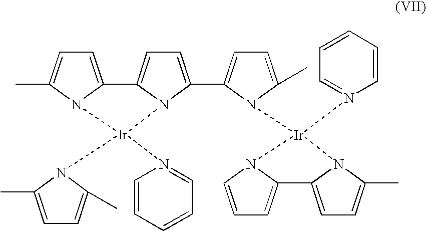

The catalyst material of the present invention obtained as above, a catalyst material with a coating of a polynuclear complex consisting of polynuclear polymer having a catalytic metal coordinated thereto, has an excellent catalytic activity, compared with an electrode material having its surface modified with a macrocyclic compound such as porphyrin. And the catalyst material can be used as a catalyst which takes the place of platinum (Pt) or its alloys, for example, as an electrode catalyst for cathodes of various types of fuel cells.

An electrode catalyst material for the cathodes (oxygen or air electrode) of fuel cells is required to have catalytic action on the oxygen reduction reactions shown below, thereby accelerating such reactions. Specifically, when oxygen (O₂), proton (H⁺) and electron (e⁻) are supplied, the oxygen reduction reaction, such as 4-electron reduction of oxygen expressed by the following reaction formula (1) or the 2+2-electron reduction of oxygen expressed by the following reaction formulae (2) and (3), is accelerated through the catalysis of the catalyst material at an effective high potential.

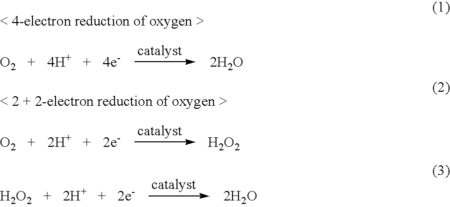

In the present invention, the peak potential of oxygen reduction obtained by cyclic voltammetry (CV) and rotating disk electrode (RDE) measurement is 0.54 V vs. SCE and the number of the electrons involved in the reaction is close to 4, as described later. This performance is comparable to the catalyst performance of platinum or its alloys which are currently used as an electrode catalyst material for the cathodes (oxygen or air electrodes) of fuel cells. This shows that the catalyst material of the present invention can be used as an electrode catalyst material for the cathodes (oxygen or air electrodes) of fuel cells.

The catalyst material of the present invention, which is obtained as above, preferably contains a second metal as the other metal element and/or its ion. Examples of the second metal and/or the ion include: nickel, titanium, vanadium, chromium, manganese, iron, copper, zinc, zirconium, niobium, molybdenum, ruthenium, rhodium, palladium, silver, cadmium, tungsten, osmium, iridium, platinum, gold and mercury. Of these metals and/or their ions, nickel (Ni) is particularly preferably used. The catalyst material containing a second metal and/or its ion can be prepared by adding a second metal and/or its ion when coordinating a catalytic metal, such as cobalt, to the coordination sites which are made up of polynuclear molecules. For example, the catalyst material containing a second metal and/or its ion can be prepared by refluxing the conductive material coated with a heteromonocyclic compound, cobalt acetate and nickel acetate in a methanol solution.

If the catalyst material of the present invention contains a second metal and/or its ion, its oxidation reduction performance is much more improved. Thus, the catalyst material containing a second metal and/or its ion has a catalytic performance sufficient to meet the requirement imposed when it is used for fuel cells etc., and therefore, has serviceability.

In preparation of a catalyst material of the present invention, it is preferable to heat treat the catalyst material obtained by coordinating a catalytic metal to coordination sites, which are formed by the polynuclear polymer derived from a heteromonocyclic compound. And it is more preferable to carry out the heat treatment in an atmosphere of an inert gas.

Specifically, a catalyst material including a polynuclear polymer is prepared by electrochemically polymerizing a heteromonocyclic compound to yield a polynuclear polymer so that a conductive material is coated with the polynuclear polymer and then allowing a catalytic metal to act on the coating layer so that the catalytic metal is coordinated to the coating layer, as described above. In this process, it is preferable to heat treat the catalytic material after coordinating the catalytic metal.

This heat treatment is carried out, for example, in such a manner that the temperature of the catalyst material is increased from the starting temperature (usually ordinary temperature) to a set temperature, kept at the set temperature for a certain period of time, and decreased little by little. The treatment temperature used in this heat treatment means the temperature at which the catalyst material is kept for a certain period of time. For example, the cell is evacuated to a desired pressure while being kept at the starting temperature, heated at a heating rate of 5° C./min to a set temperature T (T=about 400 to 700° C.), kept at the set temperature T for about 2 to 4 hours, and cooled to room temperature over about 2 hours.

As described above, heat treating the catalyst material results in further improvement of oxidation reduction performance of the catalyst material. Thus, the catalyst material having undergone heat treatment is allowed to have a catalytic performance sufficient to meet the requirement imposed when it is used for fuel cells etc., thereby having serviceability.

In the following the present invention will be described in more detail by examples; however, it is to be understood that the invention is not limited to these examples.

### Example 1

### Cobalt+Palladium/Polypyrrole/Carbon-Based Catalyst Material

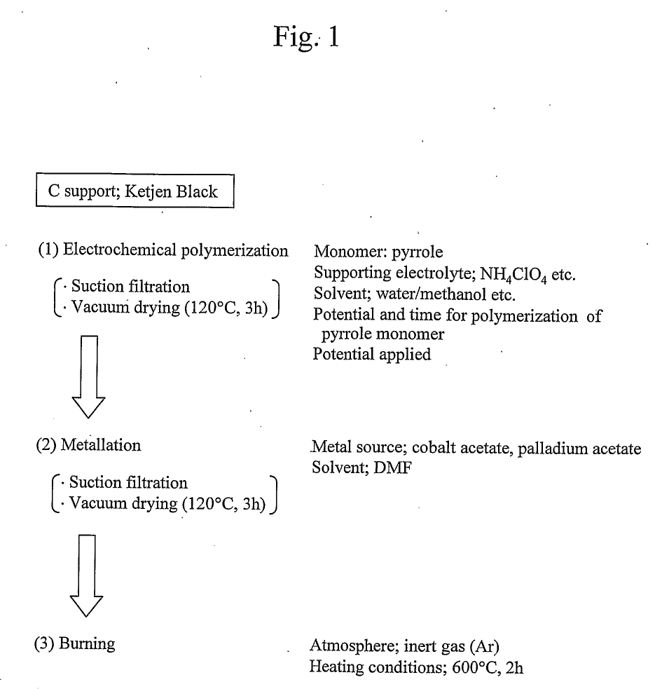

A cobalt+palladium/polypyrrole/carbon-based catalyst material (hereinafter abbreviated as “Co+Pd/Ppy/C”) was prepared following the flow shown in FIG. 1.

### (1) “Electrochemical Polymerization”

In 200 ml of water/methanol mixed solvent containing 0.1 M ammonium perchlorate or PTS as a supporting electrolyte, was dissolved 5.4 ml of pyrrole and 3 g of carbon particles (Ketjen Black). After 30-minute argon deaeration, electrochemical polymerization was performed using a fluidized bed electrode for 45 minutes by constant potential method at applied voltages of 1.8, 1.2 and 1.3 V to yield polypyrrole-coated carbon particles.

The amount of pyrrole used was 10 times the amount calculated based on the assumption that polypyrrole was attached to the surface area (800 m²/g) of Ketjen Black carbon particles leaving no space among them.

### (2) “Metallation”

On the polypyrrole-coated carbon particles obtained by the above (1) electrochemical polymerization, cobalt metal and palladium metal were supported in the following manner. Specifically, 2 g of polypyrrole-coated carbon particles, 4.08 g of cobalt acetate and 1.84 g of palladium acetate were put in a 200 ml eggplant-shaped flask and DMF was added thereto. After 30-minute argon deaeration, the mixture was refluxed for 2 hours. The mixture was then subjected to suction filtration to filter off the solid content, and the solid content was vacuum dried at 120° C. for 3 hours to yield carbon particles coated with electrochemically polymerized polypyrrole film having a pyrrole-cobalt complex (catalyst particles).

### (3) Burning

The carbon particles coated with electrochemically polymerized polypyrrole film of pyrrole-cobalt complex (catalyst particles) obtained through the above (2) metallation was heat treated at 600° C. for 2 hours in an atmosphere of argon gas.

Cyclic voltammetry (CV) and rotating disk electrode (RDE) measurements were made for the heat treated catalyst material to measure the peak potential and peak current density.

The measurements were made under the following conditions.

### [CV (Cyclic Voltammetry) and RDE]

### (Rotating Disk Electrode) Measurement:

Measuring Instruments:
Potentiostat [Nikkou Keisoku, DPGS-1]
Function generator [Nikkou Keisoku, NFG-5]
X-Y recorder [Rikendenshi, D-72DG]

Working Electrode:
Edge plane pyrolytic graphite (EPG) electrode

Reference Electrode:
Saturated Calomel electrode (SCE)

Counter Electrode:
Platinum wire

Supporting electrolyte: 1.0 M HClO₄ aqueous solution

Sweeping range: 600 to −600 mV

Sweeping rate: 100 mV/sec (CV), 10 mV/sec (RDE)

Rotation rate: 100, 200, 400, 600, 900 rpm (RDE)

Measuring Method:

In CV measurement for a complex alone, measurement was made using, as a working electrode, an electrode obtained by dissolving 20 mg of complex in 10 ml of methanol, casting 10 μl of the resultant complex solution over an edge plane pyrolytic graphite (EPG) electrode and further casting 8 μl of the mixed solution of Nafion and 2-propanol over the EPG electrode.

In 250 μl of Nafion solution, 20 mg of carbon-based particles having undergone each treatment was dispersed, and 20 μl of the dispersion was cast over an EPD electrode.

The results of Example 1 are shown in Table 1.

TABLE 1

| | | | | Peak current | |
|---|---|---|---|---|---|
| Applied voltage | | Supporting | Peak potential | density | |
| [V vs. Ag/AgCl] | Solvent | electrolyte | Ep [V vs. SCE] | Ip (mA/cm²) | Notes |
| 1.8 | water/methanol = 4/1 | NH₄ClO₄ | +0.48 | 2.00 | Normal electrochemical |
| | | | | | polymerization potential |
| 1.2 | water/methanol = 4/1 | NH₄ClO₄ | +0.54 | 4.71 | Polymerization potential |
| | | | | | in the range of the |
| | | | | | present invention |
| 1.3 | water/methanol = 1/1 | PTS | +0.52 | 4.29 | Polymerization potential |
| | | | | | in the range of the |
| | | | | | present invention |

The results shown in Table 1 reveal that in a cobalt+palladium/polypyrrole/carbon-based catalyst material (Co+Pd/Ppy/C), examining the preparation conditions (potential applied, supporting electrolyte and solvent composition) during electrochemical polymerization makes it possible to produce high oxygen reduction potential and peak current density, thereby yielding a highly active catalyst.

The detailed mechanism of increasing the performance of a catalyst material has not been clarified yet at the present time; however, it is apparent that examining the preparation conditions during electrochemical polymerization restrains the occurrence of side reaction (3,4-position crosslinking polymerization) during pyrrole polymerization reaction, whereby the main reaction (2,5-position polymerization), which is highly electron-conductive, progresses. This high electron-conductivity probably contributes to increasing the catalyst activity (especially reduction current).

In Table 2, are shown the measurements of the peak potentials Ep (V vs. SCE), peak potentials Ep (V vs. NHE) and peak current densities Ip (mA/cm²) before heat treatment (before reflux) and after heat treatment in Example 1.

TABLE 2

| | | | | | Peak current |
|---|---|---|---|---|---|
| Applied voltage | | Supporting | Peak potential | Peak potential | density Ip |
| [V vs. Ag/AgCl] | Operation | electrolyte | Ep [V vs. SCE] | Ep [V vs. NHE] | (mA/cm²) |
| 1.8 | After reflux | NH₄ClO₄ | +0.56 | +0.8 | 0.84 |
| | After heat | | +0.48 | +0.72 | 2.00 |
| | treatment | | | | |
| 1.2 | After reflux | NH₄ClO₄ | +0.31 | +0.55 | 1.61 |
| | After heat | | +0.54 | +0.78 | 4.71 |
| | treatment | | | | |
| 1.3 | After reflux | PTS | +0.35 | +0.59 | 1.57 |
| | After heat | | +0.52 | +0.76 | 4.29 |
| | treatment | | | | |

Comparing the results of Table 2 at an applied voltage of 1.8 V and at an applied voltage of 1.2 V reveals the effect of the potential applied. Specifically, when applying a voltage of 1.8 V, the increase in power generation performance due to heat treatment is significant compared with when applying a voltage of 1.2 V. Comparing the results of Table 2 at an applied voltage of 1.2 V and at an applied voltage of 1.3 V also reveals the effect of the supporting electrolyte used. Specifically, when applying a voltage of 1.2 V and using NH₄ClO₄ as a supporting electrolyte, the increase in power generation performance due to heat treatment is significant compared with when applying a voltage of 1.3 V and using PTS as a supporting electrolyte.

### Example 2

### Preparation of Catalyst Material Using a Polymerizable Ligand, 2-(1H-pyrrol-3-ylpyridine)

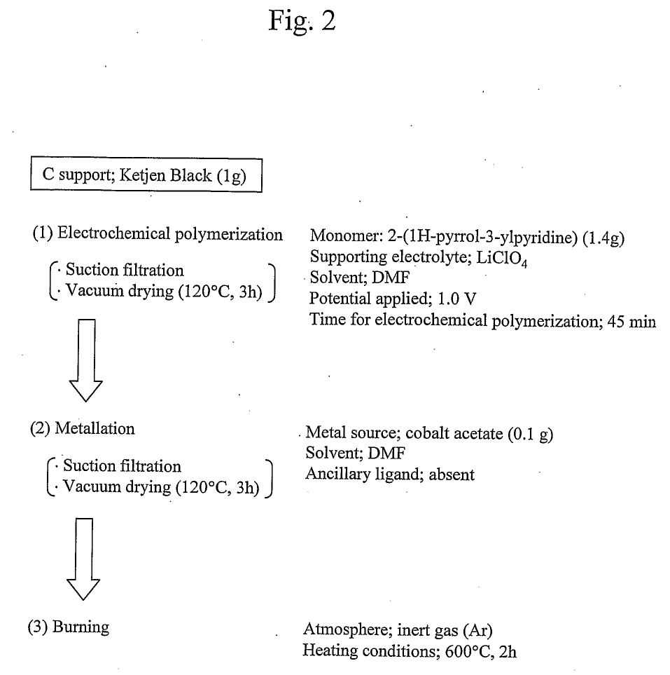

A catalyst material was prepared, following the flow shown in FIG. 2, using 2-(1H-pyrrol-3-ylpyridine) (pyPy), a polymerizable ligand where pyridine, which has a strong coordinating tendency to Co, and pyrrole, which is polymerizable, are bonded together, so that the material has an increased density of “Co—N4 structure”.

### (1) “Electrochemical Polymerization”

In 200 ml of DMF solvent containing 0.1 M LiClO₄ as a supporting electrolyte, was dissolved 1.4 g of 2-(1H-pyrrol-3-ylpyridine) (pyPy) and 1 g of carbon particles (Ketjen Black). After 30-minute argon deaeration, electrochemical polymerization was performed using a fluidized bed electrode for 45 minutes by constant potential method at an applied voltage of 1.0 V to yield poly(2-(1H-pyrrol-3-ylpyridine))-coated carbon particles.

The amount of 2-(1H-pyrrol-3-ylpyridine) used was 10 times the amount calculated based on the assumption that poly(2-(1H-pyrrol-3-ylpyridine)) was attached to the surface area (800 m²/g) of Ketjen Black carbon particles leaving no space among them.

### (2) “Metallation”

On the poly(2-(1H-pyrrol-3-ylpyridine))-coated carbon particles obtained by the above (1) electrochemical polymerization, cobalt metal was supported in the following manner. Specifically, 2 g of poly(2-(1H-pyrrol-3-ylpyridine))-coated carbon particles and 4.08 g of cobalt acetate were put in a 200 ml eggplant-shaped flask and DMF or methanol was added thereto. After 30-minute argon deaeration, the mixture was refluxed for 2 hours. The mixture was then subjected to suction filtration to filter off the solid content, and the solid content was vacuum dried at 120° C. for 3 hours to yield carbon particles coated with electrochemically polymerized poly(2-(1H-pyrrol-3-ylpyridine)) film having a cobalt complex (catalyst particles).

### (3) Burning

The carbon particles coated with electrochemically polymerized poly(2-(1H-pyrrol-3-ylpyridine)) film having a cobalt complex (catalyst particles) obtained through the above (2) metallation was heat treated at 600° C. for 2 hours in an atmosphere of argon gas.

Cyclic voltammetry (CV) and rotating disk electrode (RDE) measurements were made for the heat treated catalyst material to measure the peak potential and peak current density.

The results of Example 2 are shown in Table 3.

TABLE 3

| | | Peak potential | Peak current density | |
|---|---|---|---|---|
| Solvent | Burning | Ep [V vs. SCE] | Ip (mA/cm²) | Notes |
| Methanol | Absent | +0.01 | 1.42 | Comparative Example |
| DMF | Absent | +0.05 | 0.62 | Comparative Example |
| DMF | Present (600° C.) | +0.20 | 0.89 | Example of the present |
| | | | | invention |

The results shown in Table 3 reveal that in a fuel cell cathode catalyst prepared using 2-(1H-pyrrol-3-ylpyridine) (pyPy), a polymerizable ligand where pyridine, which has a strong coordinating tendency to Co, and pyrrole, which is polymerizable, are bonded together, so that the material has an increased density of “Co—N4 structure”, examining the preparation conditions (solvent used during the coordination of metal and the presence or absence of burning) makes it possible to produce high oxygen reduction potential and peak current density, thereby yielding a highly active catalyst.

The detailed mechanism of increasing the performance of a catalyst material has not been clarified yet at the present time; however, the use of 2-(1H-pyrrol-3-ylpyridine) (pyPy), a polymerizable ligand where pyridine, which has a strong coordinating tendency to Co, and pyrrole, which is polymerizable, are bonded together, possibly enables the catalyst material to support active species densely.

### Example 3

### Examination of Conductive Material as a Support

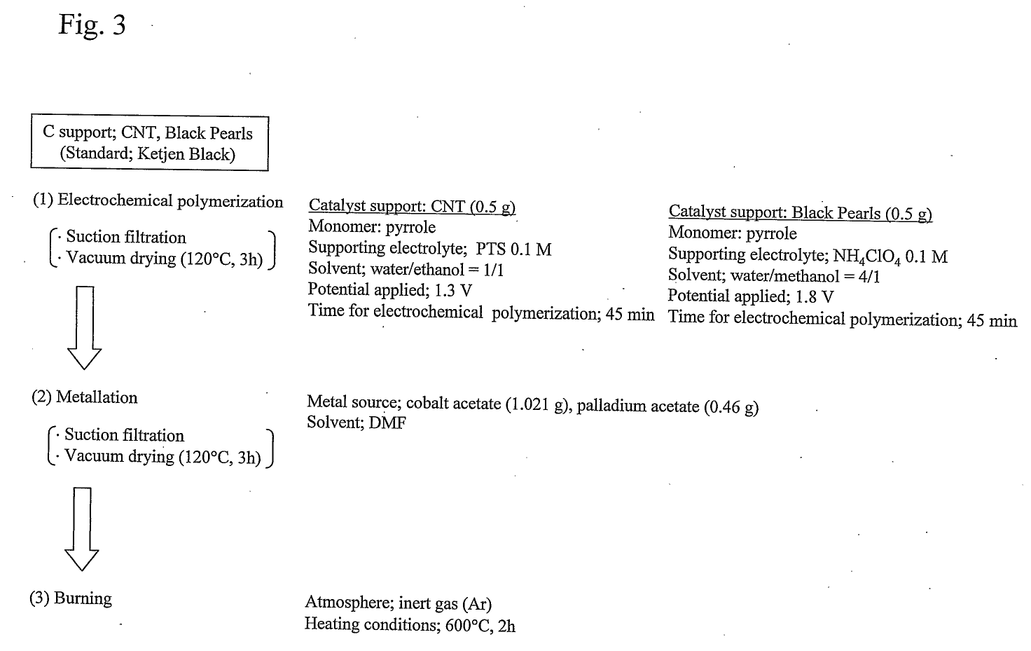

Catalyst materials were prepared, following the flow shown in FIG. 3, using as a catalyst support carbon nanotube (CNT) and Black Pearls (brand name), respectively.

### (1) “Electrochemical Polymerization”

In 200 ml of DMF solvent containing 0.1 M PTS as a supporting electrolyte, was dissolved 0.9 mL of pyrrole and 0.5 g of carbon nanotubes (CNTs). After 30-minute argon deaeration, electrochemical polymerization was performed using a fluidized bed electrode for 45 minutes by constant potential method at an applied voltage of 1.3 V to yield polypyrrole-coated CNTs.

Likewise, 0.9 mL of pyrrole and 0.5 g of Black Pearls were dissolved in 200 ml of water/methanol=4/1 mixed solvent containing 0.1 M NH₄ClO₄ as a supporting electrolyte. After 30-minute argon deaeration, electrochemical polymerization was performed using a fluidized bed electrode for 45 minutes by constant potential method at an applied voltage of 1.8 V to yield polypyrrole-coated Black Pearls.

### (2) “Metallation”

On the polypyrrole-coated CNTs and polypyrrole-coated Black Pearls obtained by the above (1) electrochemical polymerization, cobalt metal and palladium metal were supported in the following manner. Specifically, 2 g of polypyrrole-coated carbon particles, 4.08 g of cobalt acetate and 1.84 g of palladium acetate were put in a 200 ml eggplant-shaped flask and DMF was added thereto. After 30-minute argon deaeration, the mixture was refluxed for 2 hours. The mixture was then subjected to suction filtration to filter off the solid content, and the solid content was vacuum dried at 120° C. for 3 hours to yield CNTs and Black Pearls coated with electrochemically polymerized polypyrrole film of cobalt/palladium-electrochemically polymerized polypyrrole film complex (catalyst particles).

### (3) Burning

The CNTs and Black Pearls coated with electrochemically polymerized polypyrrole film having a cobalt/palladium complex (catalyst particles) obtained through the above (2) metallation was heat treated at 600° C. for 2 hours in an atmosphere of argon gas.

Cyclic voltammetry (CV) and rotating disk electrode (RDE) measurements were made for the heat treated catalyst materials to measure the peak potential and peak current density.

The results of Example 3 are shown in Table 4. The average particle size of CNTs was 3 to 10 nm.

TABLE 4

| | Peak potential | Peak current density | |
|---|---|---|---|
| Carbon support | Ep [V vs. SCE] | Ip (mA/cm²) | Notes |
| CNT | +0.52 | 4.00 | Example of the |
| (3~10 nm) | | | present invention |

The results shown in Table 4 reveal that the use of CNTs as a carbon support makes it possible to prepare a catalyst material having significantly improved catalytic activity. In this preparation, the percentage of the noble metal supported on the carbon support was allowed to be 20% by weight and the total percentage of the metals supported on the carbon support 20 to 25% by weight.

The detailed mechanism of increasing the performance of a catalyst material has not been clarified yet at the present time; however, the use of CNTs, which have higher conductivity than Ketjen Black as a standard carbon material, probably enables the catalyst material to support active species densely.

Table 5 shows the comparison made among the catalyst materials using, as a carbon support, Black Pearls 2000 (brand name), Ketjen Black (brand name), Prentex XE-2 (brand name), Vulcan XC-72R (brand name) and acetylene black, respectively.

TABLE 5

| | Specific | | | | Peak potential Ep | Peak current density |
|---|---|---|---|---|---|---|
| | surface area | Average | Co-t- | Amount of | [V vs. SCE] | Ip (mA/cm²) |
| | (N2 - BET | particle | EtP | carbon | Before heat treatment | Before heat treatment |
| Support | method [m²/g]) | size [nm] | [g] | [g] | After heat treatment | After heat treatment |
| Black Pearls | 1500 | <30 | 184.7 | 500 | 0.48 | 2.1 |
| 2000 | | | | | 0.51 | 2.1 |
| Ketjen Black | 800 | 39.5 | 98.3 | 500 | 0.44 | 2.3 |
| | | | | | 0.51 | 3.0 |
| Prentex XE-2 | 950 | 30 | 117 | 500 | 0.46 | 2.7 |
| | | | | | 0.49 | 2.8 |
| Vulcan XC-72R | 254 | 30 | 31.3 | 500 | 0.36 | 1.4 |
| | | | | | 0.35 | 1.6 |
| Acetylene | 68 | 35 | 8.4 | 500 | 0.34 | 2.1 |
| Black | | | | | 0.34 | 2.9 |

The results shown in Table 5 reveal that the catalyst materials using, as a carbon support, Black Pearls 2000 (brand name), Ketjen Black (brand name) and Prentex XE-2 (brand name), respectively, have good power generation performance.

### Example 4

### Multiple Electrochemical Polymerization

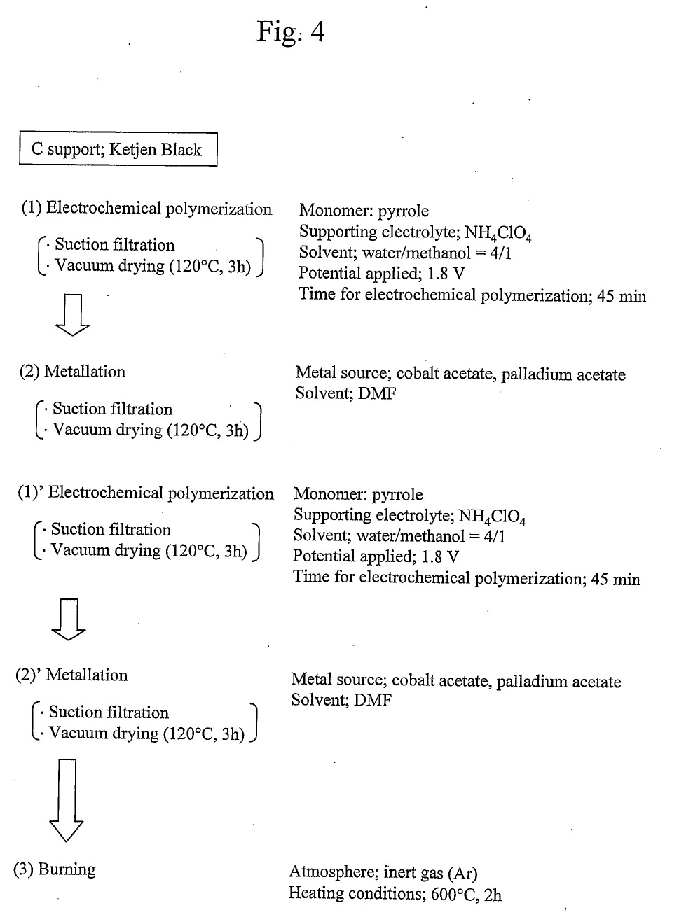

A catalyst material was prepared by repeating electrochemical polymerization and metallation, following the flow diagram shown in FIG. 4.

(1) “Electrochemical polymerization I”

In 200 ml of water/methanol=4/1 mixed solvent containing 0.1 M NH₄ClO₄ as a supporting electrolyte, 0.9 mL of pyrrole and 0.5 g of Ketjen Black were dissolved. After 30-minute argon deaeration, electrochemical polymerization was performed using a fluidized bed electrode for 45 minutes by constant potential method at an applied voltage of 1.8 V to yield polypyrrole-coated Ketjen Black.

### (2) “Metallation I”

On the polypyrrole-coated Ketjen Black obtained by the above (1) electrochemical polymerization, cobalt metal and palladium metal were supported in the following manner. Specifically, 2 g of polypyrrole-coated carbon particles, 4.08 g of cobalt acetate and 1.64 g of palladium acetate were put in a 200 ml eggplant-shaped flask and DMF was added thereto. After 30-minute argon deaeration, the mixture was refluxed for 2 hours. The mixture was then subjected to suction filtration to filter off the solid content, and the solid content was vacuum dried at 120° C. for 3 hours to yield Ketjen Black coated with cobalt/palladium-electrochemically polymerized polypyrrole film complex (catalyst particles I).

(3) “Electrochemical polymerization II”

In 200 ml of water/methanol=4/1 mixed solvent containing 0.1 M NH₄ClO₄ as a supporting electrolyte, Ketjen Black coated with electrochemically polymerized polypyrrole film of cobalt/palladium-pyrrole complex (catalyst particles I) and the 0.9 mL of pyrrole, like electrochemical polymerization I, were dissolved. After 30-minute argon deaeration, electrochemical polymerization was performed using a fluidized bed electrode for 45 minutes by constant potential method at an applied voltage of 1.8 V to yield Ketjen Black again coated with polypyrrole.

### (4) “Metallation II”

On the polypyrrole-coated Ketjen Black obtained by the above (3) electrochemical polymerization, cobalt metal and palladium metal were supported again. Specifically, 2 g of polypyrrole-coated carbon particles, 4.08 g of cobalt acetate and 1.64 g of palladium acetate were put in a 200 ml eggplant-shaped flask and DMF was added thereto. After 30-minute argon deaeration, the mixture was refluxed for 2 hours. The mixture was then subjected to suction filtration to filter off the solid content, and the solid content was vacuum dried at 120° C. for 3 hours to yield Ketjen Black coated with cobalt/palladium-electrochemically polymerized polypyrrole film complex (catalyst particles II).

### (5) “Burning”

The Ketjen Black coated with electrochemically polymerized polypyrrole film of cobalt/palladium-pyrrole complex (catalyst particles II) obtained through the above (4) metallation was heat treated at 600° C. for 2 hours in an atmosphere of argon gas.

Cyclic voltammetry (CV) and rotating disk electrode (RDE) measurements were made for the heat treated catalyst materials to measure the peak potential.

The results of Example 4 are shown in Table 6.

TABLE 6

| Number of times of | Peak | |
|---|---|---|
| electrochemical polymerization | potential Ep | |
| and metallation | [V vs. SCE] | Notes |
| 1 | +0.48 | Comparative Example |
| 2 (Multiple electrochemical | +0.50 | Example of the |
| polymerization) | | present invention |

The results shown in Table 6 reveal that a catalyst material prepared by repeating the steps of (1) electrochemical polymerization of multinuclear polymer (Ppy) on a conductive material (carbon)→(2) matallation of catalytic metals (Co, Pd) twice, followed by heat treatment is allowed to have significantly improved catalytic activity.

The detailed mechanism of increasing the performance of a catalyst material has not been clarified yet at the present time; however, repeating the steps of allowing carbon particles to support a polynuclear complex and coordinating catalytic metal to the complex probably enables the catalyst material to support active species densely.

### Example 5

### Combination of Multiple Electrochemical Polymerization and Ancillary Ligand

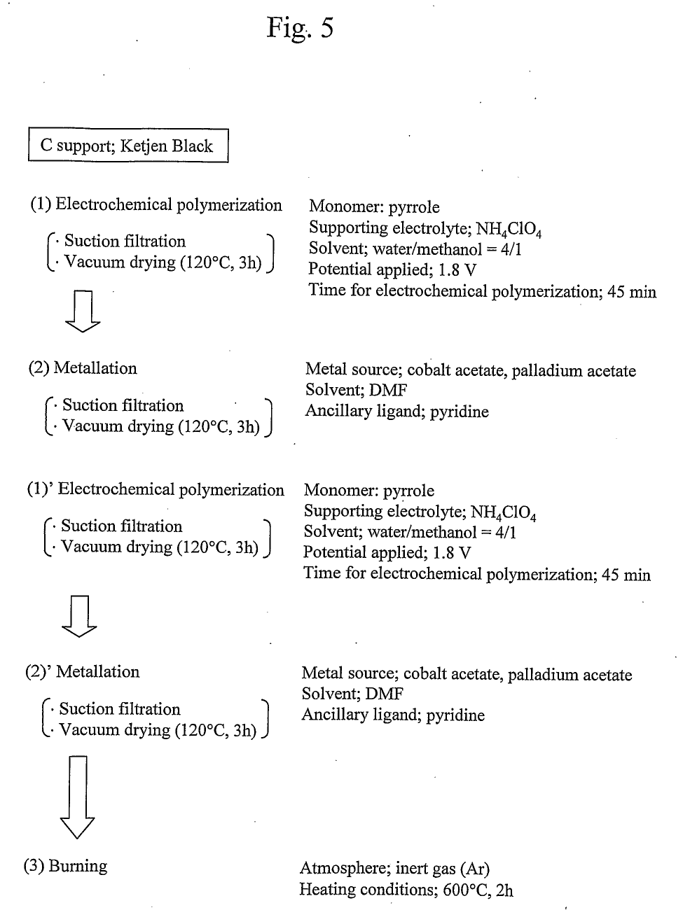

A catalyst material was prepared by repeating electrochemical polymerization and metallation using an ancillary ligand, following the flow shown in FIG. 5.

### (1) “Electrochemical Polymerization I”

In 200 ml of water/methanol=4/1 mixed solvent containing 0.1 M NH₄ClO₄ as a supporting electrolyte, 0.9 mL of pyrrole and 0.5 g of Ketjen Black were dissolved. After 30-minute argon deaeration, electrochemical polymerization was performed using a fluidized bed electrode for 45 minutes by constant potential method at an applied voltage of 1.8 V to yield polypyrrole-coated Ketjen Black.

### (2) “Metallation I”

On the polypyrrole-coated Ketjen Black obtained by the above (1) electrochemical polymerization, cobalt metal and palladium metal were supported in the following manner. Specifically, 2 g of polypyrrole-coated carbon particles, 4.08 g of cobalt acetate and 1.64 g of palladium acetate were put in a 200 ml eggplant-shaped flask and DMF was added thereto. After 30-minute argon deaeration, the mixture was refluxed for 2 hours. The mixture was then subjected to suction filtration to filter off the solid content, and the solid content was vacuum dried at 120° C. for 3 hours to yield Ketjen Black coated with cobalt/palladium-electrochemically polymerized polypyrrole film complex (catalyst particles I).

### (3) “Electrochemical Polymerization II”

In 200 ml of water/methanol=4/1 mixed solvent containing 0.1 M NH₄ClO₄ as a supporting electrolyte, Ketjen Black coated with electrochemically polymerized polypyrrole film of cobalt/palladium-pyrrole complex (catalyst particles I), and the 0.9 mL of pyrrole, like electrochemical polymerization I, were dissolved. After 30-minute argon deaeration, electrochemical polymerization was performed using a fluidized bed electrode for 45 minutes by constant potential method at an applied voltage of 1.8 V to yield Ketjen Black again coated with polypyrrole.

### (4) “Metallation I”

On the polypyrrole-coated Ketjen Black obtained by the above (3) electrochemical polymerization, cobalt metal and palladium metal were supported again. Specifically, 2 g of polypyrrole-coated carbon particles, 4.08 g of cobalt acetate and 1.84 g of palladium acetate were put in a 200 ml eggplant-shaped flask, 0.139 mL of pyridine as an ancillary ligand was added, and DMF was also added thereto. After 30-minute argon deaeration, the mixture was refluxed for 2 hours. The mixture was then subjected to suction filtration to filter off the solid content, and the solid content was vacuum dried at 120° C. for 3 hours to yield Ketjen Black coated with cobalt/palladium-electrochemically polymerized polypyrrole film complex (catalyst particles II).

### (5) “Burning”

The Ketjen Black coated with electrochemically polymerized polypyrrole film of cobalt/palladium-pyrrole complex (catalyst particles II) obtained through the above (4) metallation was heat treated at 600° C. for 2 hours in an atmosphere of argon gas.

Cyclic voltammetry (CV) and rotating disk electrode (RDE) measurements were made for the heat treated catalyst materials to measure the peak potential.

The results of Example 5 are shown in Table 7.

TABLE 7

| Number of times of electrochemical | Presence or absence | Peak potential | Peak current density | |
|---|---|---|---|---|
| polymerization and metallation | of ancillary ligand | Ep [V vs. SCE] | Ip (mA/cm²) | Notes |
| 1 | Absent | +0.48 | 2.00 | Comparative |
| | | | | Example |
| 2 (Multiple electrochemical polymerization) | Absent | +0.50 | 1.70 | Example of the |
| | | | | present invention |
| 2 (Multiple electrochemical polymerization) | Present | +0.52 | 2.89 | Example of the |
| | | | | present invention |

The results shown in Table 7 reveal that a catalyst material prepared by repeating the steps of (1) electrochemical polymerization of multinuclear polymer (Ppy) on a conductive material (carbon)→(2) matallation of catalytic metals (Co, Pd) twice, followed by heat treatment is allowed to have significantly improved catalytic activity. Particularly, the metallation using an ancillary ligand can improve the catalytic activity of a catalyst material more markedly than the metallation using no ancillary ligand.

The detailed mechanism of increasing the performance of a catalyst material has not been clarified yet at the present time; however, repeating the steps of allowing carbon particles to support a polynuclear complex and coordinating catalytic metal to the complex probably enables the catalyst material to support active species densely. And the use of an ancillary ligand probably increases the amount of the catalytic metal coordinated.

### INDUSTRIAL APPLICABILITY

The catalyst material of the present invention is a catalyst material prepared by allowing catalytic metal(s) to be supported on a polynuclear polymer, which is obtained by electrochemical polymerization under the specified conditions, whereby it has an excellent catalytic activity and produces an improved effect of restraining the production of hydrogen peroxide when used as a catalyst for fuel cells. Thus, the present invention contributes to spreading the use of fuel cells.

1. A process for preparing a catalyst material, comprising: an electrochemical polymerization step of electrochemically polymerizing a heteromonocyclic compound so that the surface of a conductive material is coated with a polynuclear complex molecule derived from the heteromonocyclic compound; and a metallation step of coordinating a catalytic metal to the coating layer of the polynuclear complex molecule, characterized in that the potential applied in the electrochemical polymerization is 0.8 to 1.5 V.

2. The process for preparing a catalyst material according to claim 1, characterized in that the electrochemical polymerization step is carried out in a water-methanol or water-ethanol mixed solvent.

3. The process for preparing a catalyst material according to claim 1 or 2, characterized in that the electrochemical polymerization step is carried out using NH₄ClO₄ or PTS as a supporting electrolyte.

4. The process for preparing a catalyst material according to any one of claims 1 to 3, characterized in that 2-(1H-pyrrol-3-ylpyridine) is used as the heteromonocyclic compound.

5. The process for preparing a catalyst material according to any one of claims 1 to 4, characterized in that the conductive material has a specific surface area of 500 to 2000 m²/g.

6. The process for preparing a catalyst material according to any one of claims 1 to 5, characterized in that the conductive material has an average particle size of 3 to 30 nm.

7. The process for preparing a catalyst material according to any one of claims 1 to 6, comprising: an electrochemical polymerization step of electrochemically polymerizing a heteromonocyclic compound so that the surface of a conductive material is coated with a polynuclear polymer derived from the heteromonocyclic compound; and a metallation step of coordinating a catalytic metal to the coating layer of the polynuclear polymer to form polynuclear complex molecules, characterized in that the electrochemical polymerization step and/or the metallation step is carried out more than one time.

8. The process for preparing a catalyst material according to any one of claims 1 to 7, characterized in that in the electrochemical polymerization step, at least two heteromonocyclic compounds are electrochemically polymerized.

9. The process for preparing a catalyst material according to any one of claims 1 to 8, characterized in that in the metallation step, a noble metal and a transition metal are coordinated at the same time.

10. The process for preparing a catalyst material according to any one of claims 1 to 9, further comprising a heat treatment step carried out after the metallation step.

11. The process for preparing a catalyst material according to any one of claims 1 to 10, further comprising a step of coordinating a nitrogen-containing low-molecular-weight heterocyclic compound, as an ancillary ligand, to the catalytic metal.

12. The process for preparing a catalyst material according to claim 1, characterized in that the nitrogen-containing low-molecular-weight compound is pyridine and/or phenanthroline.

13. The process for preparing a catalyst material according to any one of claims 9 to 12, characterized in that the noble metal is one or more selected from the group consisting of palladium (Pd), iridium (Ir), rhodium (Rh) and platinum (Pt) and the transition metal is one or more selected from the group consisting of cobalt (Co), iron (Fe), molybdenum (Mo) and chromium (Cr).

14. A catalyst material, prepared by the process according to any one of claims 1 to 13.

15. A catalyst for fuel cells, comprising the catalyst material prepared by the process according to any one of claims 1 to 13.

16. Fuel cells, comprising, as a catalyst for fuel cells, the catalyst material prepared by the process according to any one of claims 1 to 13.
